(19) United States
(12) Patent Application Publication
(10) Pub. No.: US 2025/0345735 A1
(43) Pub. Date: Nov. 13, 2025

(54) NOISE SUPPRESSION AIR FILTER FOR AN AIR COMPRESSOR

(71) Applicant: Air Lift Company, Lansing, MI (US)

(72) Inventors: James Mohan, Lansing, MI (US); Jaxx Liedel, Lansing, MI (US)

(21) Appl. No.: 19/097,297

(22) Filed: Apr. 1, 2025

Related U.S. Application Data
(60) Provisional application No. 63/644,104, filed on May 8, 2024.

(51) Int. Cl. B01D 46/00; B01D 46/24; B01D 46/42; F04B 53/00

(52) U.S. Cl. CPC B01D 46/0049; B01D 46/2403; B01D 46/4236; F04B 53/001

(57) ABSTRACT

A spiral noise suppression air filter apparatus to reduce compressor noise through a structured airflow path and related method of use. The air filter includes a filter base, a filter cap, and one or more curvilinear walls extending between the base and the cap, creating a spiral air flow channel. The spiral configuration of the curvilinear walls allows for suppression of noise by directing air through a noise reducing path that includes an inlet and an outlet toward the center of the base. Filter media surrounds the exterior portion of the curvilinear walls, allowing air to be drawn into the noise suppression filter circumferentially. Various embodiments of the air filter include multiple curvilinear walls that follow complimentary paths to enhance airflow dynamics and noise suppression capabilities.

### CROSS-REFERENCE TO RELATED APPLICATIONS

This application claims the benefit of U.S. Provisional Application 63/644,104, filed May 8, 2024, the disclosure of which is incorporated by reference in its entirety.

### BACKGROUND OF THE INVENTION

This invention relates to the field of air compressors, and more particularly to reducing or suppressing noise generated by an air compressor.

Air compressors are commonly used in various applications. In general, they function by compressing air mechanically using a motor that drives a reciprocating piston within a cylinder head to compress air drawn into the system. Air is pulled into the piston and cylinder head through a small hole and air filtration device. Some exemplary air compressors are used for adjusting air spring pressure to maintain vehicle stability and load balance. These air spring compressors, like most dry air compressors, operate with significant noise due to air turbulence and mechanical motion within the system.

In general, air is introduced into a compressor through a configuration that does not sufficiently mitigate turbulence or direct the flow of air, which not only compromises efficiency but also escalates the level of acoustic emissions. The current air filtration and intake designs focus primarily on debris exclusion without addressing noise output. Put simply, the cycling of a motor or head inside of a compressor leads to noise generation. This noise is generated by many factors internal to the compressor, the electrical motor spinning, the reciprocation of the piston and cylinder head, and the intake of air. The reciprocation of the piston and head generate sound waves when the air is compressed against the compressor bore and seal. The intake of the air also generates sound waves due to the turbulence of the air being pulled through an open area into a smaller volume cavity which contains a rotating piston connected to the motor. The sound waves generated can reverberate through the non-compressed air and out of the compressor through the intake hole.

Air being drawn into a compressor is generally filtered through a media to eliminate particulate that could damage the compressor or any parts that are used with the compressed air. Current filters are unable to suppress these sound waves to an acceptable level due to their open design. The particle filtration size requirements for an air compressor are generally between 1 and 25 microns. The filter is generally the first component in the path for air that is being drawn in for compression, the air passes through the filter, into the bore of the compressor and then is compressed by the head and forced into an external unit for storage or usage.

The sound level generated by an air compressor can be greater than 85 dB when running. This is comparable to a gas lawn mower and is close to the acceptable risk level based on NIOSH (National Institute for Occupational Safety and Health) recommended levels. With normal conversation being approximately 60-65 dB, this creates a concern and problem for those susceptible to hearing issues, as well as hearing other sounds while the compressor runs.

There is an evident need for noise reduction in air compressors to decrease turbulence and manage acoustic emissions effectively. The present disclosure aims to fulfill this need by introducing novel air filter configurations, ensuring quieter compressor operation while maintaining desired performance characteristics.

### SUMMARY OF THE INVENTION

The embodiments disclosed herein relate to noise suppression air filters for air compression systems. The noise suppression air filters of the present disclosure incorporate a filter media and one or more curvilinear walls that form a spiral airflow channel system. The configuration of the filter media and the spiral airflow channel system effectively filter particulates out of the air and reduce noise caused by the air filter relative to an air filter without such configuration. In essence, the aerodynamics or air flow patterns provided by the combination and configuration of the noise suppression air filter components cooperate to reduce air turbulence and provide a substantial reduction in noise generated by an air compressor utilizing a noise suppression air filter of the present disclosure. Noise reduction contributions can also occur due to the additional mass of the material (e.g., curvilinear walls) which can absorb sound waves as they travel through the noise suppression air filter.

In one embodiment, the noise suppression air filter includes an interior chamber generally defined by a wall protruding generally perpendicular from a base surface. The wall follows a curvilinear path around a central axis also perpendicular to the base surface. The wall extends laterally from a generally central opening in the base surface, which defines the noise suppression air filter outlet, to the exterior edge of the base surface. The exterior edge of the curvilinear wall terminates into a filter material that generally encompasses the perimeter of the noise suppression air filter and defines the noise suppression air filter inlet. The distal end of the perpendicular wall terminates into a cap. The cap cooperates with the filter material and base to form a curvilinear airflow path, e.g., a spiral airflow channel. Air being introduced into the noise suppression air filter travels through the filter material, which acts as an air inlet, through the defined spiral airflow path, and out the air outlet defined by the central opening in the base surface.

In another embodiment, the noise suppression air filter includes multiple discrete interior chambers generally defined by a plurality of walls protruding generally perpendicular from a base surface. The walls follow curvilinear paths around a central axis also perpendicular to the base surface. The walls extend laterally from one of multiple generally central openings in the base surface, which together define the noise suppression air filter outlet, to the exterior edge of the base surface. The exterior edge of the curvilinear walls terminates into a filter material that generally encompasses the perimeter of the noise suppression air filter and defines the noise suppression air filter inlet into one of the interior chambers. The distal end of the perpendicular wall terminates into a cap. The cap cooperates with the filter material and base to form a curvilinear airflow path, e.g., a spiral airflow channel system. Air being introduced into the noise suppression air filter travels through the filter material, which acts as an air inlet, through one of the defined spiral airflow paths of the spiral airflow channel system, and out the air outlet defined by one of the central openings in the base surface.

The noise suppression air filters of the present disclosure can be integrated into an air compressor. The air filter can be disposed within a filter housing that acts as an air intake for an air compressor. As air travels through the filter housing, the air is forced to travel through the spiral airflow channel system of the noise suppression air filter, resulting in both filtration of particulates from the air and a reduced noise level (e.g., due to the enhanced airflow channel system and added mass of the spiral airflow channel system). Thus, the noise suppression air filters of the present disclosure provide effective noise reduction and air filtration, increasing compressor efficiency and environmental compatibility. These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective exploded view of a noise suppression air filter in accordance with an embodiment of the present disclosure.

FIG. 2 is a top view of the noise suppression air filter of FIG. 1 without the cap.

FIG. 3 is a perspective exploded view of a noise suppression air filter in accordance with another embodiment of the present disclosure.

FIG. 4 is a top view of the noise suppression air filter of FIG. 3 without the cap illustrating air flow pathing.

FIG. 5 is a perspective view of a compressor utilizing a noise suppression air filter in accordance with an embodiment of the present disclosure.

FIG. 6 is an exploded side view of the compressor of FIG. 5.

FIG. 7 is a top view of a noise suppression air filter in accordance with another embodiment of the present disclosure.

FIG. 8 is a perspective front view of the noise suppression air filter of FIG. 7 without the cap.

### DETAILED DESCRIPTION OF THE CURRENT EMBODIMENTS

The present disclosure is generally directed to a noise suppression air filter for filtering air and reducing noise in air compressor systems. This noise suppression air filter filters air particulates, enhances airflow dynamics, and reduces acoustic emissions by providing a structured and curved airflow path. The noise suppression air filter assembly, depicted across different embodiments in the figures, demonstrates variations in structure to provide air filtration and reduce operational noise effectively.

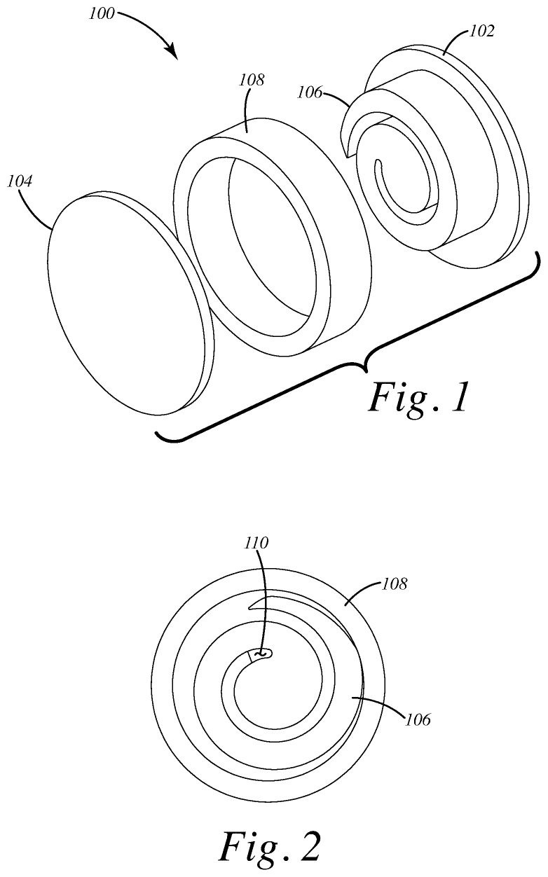

A noise suppression air filter 100 in accordance with one embodiment of the present disclosure is illustrated in FIGS. 1-2. The depicted noise suppression air filter 100 includes a base 102, a cap 104, a curvilinear wall 106 extending between the base 102 and the cap 104, and a filter media 108 disposed toward the outer edge of the base 102 and cap 104. The curvilinear wall 106 is integrally joined to the base 102 in the illustrated embodiment. In other embodiments the curvilinear wall 106 is integrally joined to the cap 104, such that the base 102 is omitted.

As shown in FIG. 1, the base 102 supports the structure of the filter assembly 100. The base 102 can be provided in the form of a cylindrical base plate manufactured from a durable plastic, moldable polymer, or other suitable material. In the current embodiment, the base plate has a diameter that generally matches the inner diameter of the compressor filter housing, in this case about 56 mm and a thickness of about 3 mm or approximately 10% of the available interior height. The selected material, sizing, and dimensions provide a suitable balance that facilitates desired filtration and noise reduction properties. Alternative materials such as metals for enhanced durability or composites for improved acoustic dampening are also feasible, depending on the application. Further, the shape and size of the base plate can also vary depending on the application, e.g., the characteristics of the compressor being used in conjunction with the noise suppression air filter.

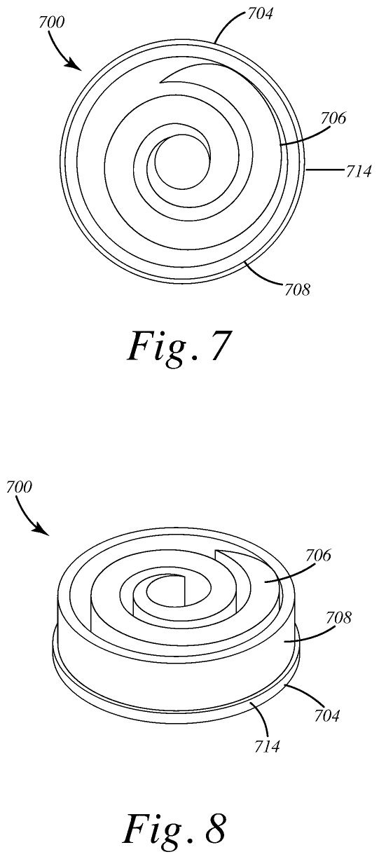

Perhaps as best shown in FIG. 2, the base plate 102 can include an aperture 110 or opening that permits airflow out of the noise suppression air filter. This air outlet 110 can be configured to be in fluid communication with the compressor air inlet to facilitate efficient air passage while maintaining the overall structural integrity of the unit. The size and positioning of the aperture 110 can vary depending on a variety of factors such as the compressor to be used in conjunction with the noise suppression air filter. For example, as shown in FIGS. 7-8, an alternative embodiment of the noise suppression air filter is depicted where the wall 706 has a tapered end 712 that leads to a larger central opening 710, which facilitates air intake for a larger compressor that demands a higher volume of effective airflow.

Referring to FIGS. 1-2, extending from the base plate 102 is a curvilinear wall 106, which defines and shapes a spiral airflow channel. The curvilinear wall 106 is generally continuous and extends perpendicular to the base plate following curvilinear paths around a central axis, extending from the central hole in the base plate to the external edge of the base plate. The wall 106 guides air in a controlled spiral manner, which smooths the airflow, reducing air turbulence and the noise typically associated with more turbulent air paths. It is worth noting that the spiral airflow channel not only aids in noise reduction but can also contribute to a more uniform airflow, which can enhance filtration efficiency.

In the depicted embodiments a gap is provided between the filter media 108, 308, 708 and the outer surface of the curvilinear wall 106, 306, 706. This ensures that air can travel easily and smoothly through the filter media 108, 308, 708 into the central chamber(s) before being directed through the spiral airflow channel. This facilitates a reduction in noise generation relative to other filters that have harsher edges and a smaller intake pathway. Sharp corners in an air flow path generate turbulence in the air due to the rapid change in velocity or vector, this turbulence creates added noise and reduces air velocity. An intake pathway that is reduced in size does not allow an ample amount of air to enter the filter and subsequently restricts the compressor intake which can result in a less efficient compressor.

FIG. 2 provides a top view of the noise suppression air filter 100 without the cap. This view illustrates the disposition of the filter media 108 surrounding the curvilinear wall 106.

The filter media 108 can be made of a fabric, semi-permeable material, or essentially any other suitable filter material. The depicted configuration ensures that air passes through the filter media 108, essentially through the side of the noise suppression air filter, and then travels through the spiral airflow channel defined by the curvilinear wall 106 toward the air outlet 110 before the air enters the compressor. The shape, size, and thickness of the curvilinear wall can vary to provide a desired airflow path and facilitate noise reduction. For example, the thickness of the wall at the tail end near the outer edge can be reduced to provide more surface area for air intake through the filter media 108.

The components 102, 106, 104, 108 of the noise suppression air filter 100 can be integrally formed or assembled permanently, temporarily, or a combination thereof. For example, in the embodiment of FIGS. 1-2, the curvilinear wall 106 is integral with the base plate and extends therefrom. The cap 104 can be permanently joined, e.g., attached, to the distal end of the wall 106 with adhesive or otherwise suitably fastened to form an enclosed space. In other embodiments the cap 104 is integrally formed with the curvilinear wall 106, optionally as an injection molded rubber insert. The filter media 108 can be friction fit in position between the cap 104 and the base 102 to facilitate replacement, or alternatively can be held in place in a more permanent fashion, for example with adhesive or other suitable fastening means. For example, the filter media 108 can be glued to the base plate 102, the cap 104, or some combination thereof. Alternatively, perhaps as best shown in FIGS. 7-8, the filter media 708 can be aligned and held in place by a track or lip 714, e.g., provided at the inner surface of the base plate 102 and/or the cap 104.

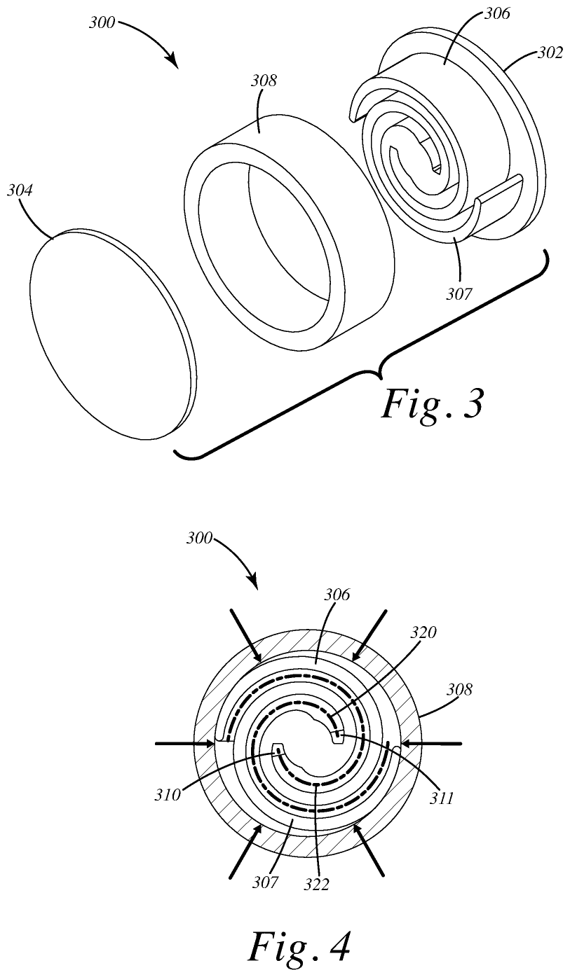

Another embodiment of a noise suppression air filter is illustrated in FIGS. 3-4 and designated 300. In this embodiment, a base plate 302 supports two sets of curvilinear walls 306, 307. These walls create a dual spiral airflow channels 320,322, enhancing the control over airflow and reducing operational compressor noise. The dual-channel design segments the airflow more distinctly, which can be particularly beneficial in applications desiring lower noise levels.

The noise suppression air filter 300 of FIGS. 3-4 also includes a filter media 308 and cap 304. Just as in the FIGS. 1-2 embodiment, the cap 304 can be permanently joined to the distal end of the wall 306 to form an enclosed space. In this embodiment, due to having multiple curvilinear walls, two distinct air flow channels are formed. The filter media 308 can be friction fit, or otherwise installed, in position between the cap 304 and base plate 302.

Perhaps as best shown in FIG. 4, multiple airflow inlet paths are provided about the circumference of the noise suppression air filter that lead to one of the two enclosed chambers and air flow paths. Each of these airflow paths terminate in a distinct and separate air outlet 310, 311. In alternative embodiments, the two air flow paths can terminate at a joint position with a single air outlet. In the depicted embodiment, because the filter media 308 interfaces and is sealed against a portion of the outer edge of the two curvilinear walls, two separate chambers are formed. In alternative embodiments with multiple curvilinear walls, a gap may be provided between the filter media and the curvilinear walls such that only a single air chamber is created by the cap, base, and filter media assembly.

Further, in alternative embodiments the noise suppression filter air inlet can includes a plurality of offset noise suppression filter air inlets formed by the exterior edges of a plurality of curvilinear walls. That is, in some embodiments, three or more distinct spiral airflow channels can be formed by three or more curvilinear walls.

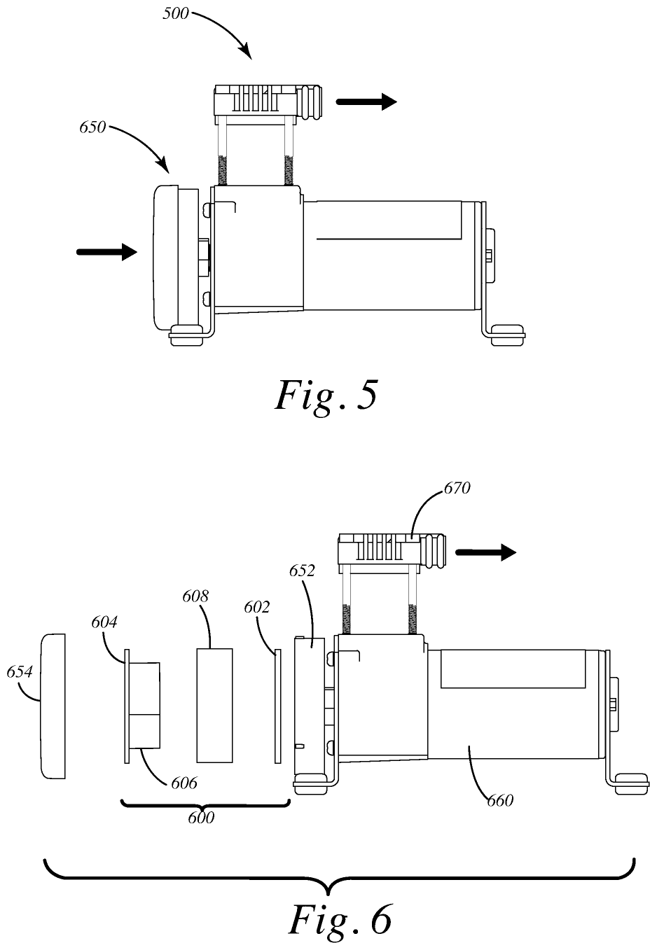

FIGS. 5-6 illustrate an embodiment of a noise suppression filter 600 installed within a compressor system, designated as 500. This configuration includes a noise suppression filter 600 housed within a filter housing 650. The filter housing includes a top shell 654 which acts as a general air intake for the compressor. That is, the top shell 654 of the filter housing can include a plurality of holes through which external air is drawn into the filter housing. After being drawn into the filter housing, air is deflected radially outward by the noise suppression air filter cap 604 before eventually being drawn through the filter media 608 that forms the circumferential outer surface of the noise suppression air filter 600. From this vantage, the air is drawn through the spiral airflow path(s) provided by the curvilinear wall(s) 606 and through the air outlet(s) disposed toward the center of the base plate 602 at the end of the airflow path(s). By forcing the air through these curved/spiral pathways, the typical noise generated is reduced/suppressed significantly. From this point, the functional components of the compressor 660 receive the filtered air at an air inlet 652 and cause the air to be compressed and output at the compressed air outlet 670. This demonstrates how the noise suppression air filter can be integrated within a compressor system to ensure seamless and quieter airflow, optimizing both noise reduction and air filtration.

In the embodiment of FIG. 6, the curvilinear wall 606 is integrally joined to the cap 604, while the base 602 is illustrated as a separate component. In other embodiments, the base 602 is omitted entirely, such that the filter 600 includes only the cap 604, the curvilinear wall 606, and the filter media 608. As shown in FIGS. 7-8 for example, the noise suppression filter 700 includes a cap 704, a curvilinear wall 706, and a filter media 708. In this embodiment, the cap 704 is integrally joined to the curvilinear wall 706, and the base is omitted entirely. The cap 704 includes a lip 714 for retention of the filter media 708. The lip 714 includes an inner diameter that is approximately equal to the outer diameter of the filter media 708, the filter media 708 being shaped as a sleeve for preventing debris from entering the spiral flow-channel. The cross-sectional area of the spiral flow-channel gradually reduces until reaching the center of the filter 700, which is aligned with a similarly-sized opening in the air compressor. The spiral flow-channel provides laminar flow to the air compressor at a much reduced decibel level compared to existing designs.

The described configurations across the exemplary embodiments 100, 300, 600, 700 not only aim to lower noise levels but also to improve the filtration capabilities of the compressor systems they are integrated into. Each noise suppression air filter allows for adjustments in materials and configuration based on specific operational needs, providing flexibility across different industrial applications.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner in one or more embodiments.

1. A spiral noise suppression air filter for reducing compressor noise, comprising:
a filter cap;
a curvilinear wall joined to the filter cap, the curvilinear wall forming a spiral air flow channel; and
a filter media surrounding the curvilinear wall, the filter media providing a noise suppression filter air inlet, wherein the noise suppression filter provides a noise reducing air flow path, the noise reducing air flow path including the noise suppression filter air inlet of the filter media and the spiral air flow channel formed by the curvilinear wall.

2. The spiral noise suppression air filter of claim 1, wherein the spiral air flow channel formed by the curvilinear wall is continuous.

3. The spiral noise suppression air filter of claim 1, including a supplemental curvilinear wall extending from the filter cap, wherein the curvilinear wall and the supplemental curvilinear wall both follow curvilinear paths around a central axis to form the spiral air flow channel that extends from the noise suppression air filter inlet to the noise suppression air filter outlet.

4. The spiral noise suppression air filter of claim 1, wherein the curvilinear wall is joined to a filter base plate, and wherein the filter base plate and filter cap cooperate with the curvilinear wall to create the spiral air flow channel.

5. The spiral noise suppression air filter of claim 4, wherein the filter media fits between and is held in place by the filter base plate and the filter cap.

6. The spiral noise suppression air filter of claim 4, including a supplemental curvilinear wall extending between the filter base plate and the filter cap, wherein the curvilinear wall and the supplemental curvilinear wall follow discrete and complimentary curvilinear paths around a central axis to form the spiral air flow channel, wherein the filter media surrounds the curvilinear wall and the supplemental curvilinear wall.

7. The spiral noise suppression air filter of claim 6, wherein the noise suppression filter air inlet includes a first noise suppression filter air inlet and a second noise suppression filter air inlet, and wherein the spiral airflow channel includes a first spiral airflow channel from the first noise suppression filter air inlet to the noise suppression air filter outlet and a second spiral airflow channel from the second noise suppression filter air inlet to the noise suppression air filter outlet.

8. The spiral noise suppression air filter of claim 4, wherein a plurality of supplemental curvilinear walls extend between the filter base plate and the filter cap, wherein the supplemental curvilinear walls each follow discrete and complimentary curvilinear paths around a central axis to form the spiral air flow channel.

9. The spiral noise suppression air filter of claim 7, wherein the noise suppression filter air inlet includes a plurality of offset noise suppression filter air inlets formed by the exterior edges of the plurality of supplemental curvilinear walls and the curvilinear wall.

10. The spiral noise suppression air filter of claim 4, wherein the base plate is a moldable polymer.

11. The spiral noise suppression air filter of claim 1, wherein the filter cap is a moldable polymer.

12. The spiral noise suppression air filter of claim 1, wherein the filter media is a semi-permeable material.

13. A compressor having a spiral noise suppression air filter, the compressor comprising:
a noise suppression air filter housing, having an air intake; and
a noise suppression air filter disposed in the noise suppression air filter housing, the noise suppression air filter comprising:
a filter cap,
a curvilinear wall joined to the filter cap, the curvilinear wall forming a spiral air flow channel, and
a filter media surrounding the curvilinear wall, the filter media providing a noise suppression filter air inlet, wherein the noise suppression air filter provides a noise reducing air flow path, the noise reducing air flow path including the noise suppression filter air inlet of the filter media and the spiral air flow channel formed by the curvilinear wall, the noise suppression air filter being configured to provide air to a compressor unit.

14. The compressor having a spiral noise suppression air filter of claim 13, wherein the spiral air flow channel formed by the curvilinear wall is continuous.

15. The compressor having a spiral noise suppression air filter of claim 13, including a supplemental curvilinear wall, wherein the curvilinear wall and the supplemental curvilinear wall both follow curvilinear paths around a central axis to form the spiral air flow channel.

16. The compressor having a spiral noise suppression air filter of claim 13, wherein the curvilinear wall extends from the filter cap to a filter base plate, wherein the filter cap is joined to the curvilinear wall opposite the base plate, and wherein the filter base plate and filter cap cooperate with the curvilinear wall to create the spiral air flow channel.

17. The compressor having a spiral noise suppression air filter of claim 16, wherein a plurality of supplemental curvilinear walls extend between the filter base plate and the filter cap, wherein the supplemental curvilinear walls each follow discrete and complimentary curvilinear paths around a central axis to form the spiral air flow channel.

18. The compressor having a spiral noise suppression air filter of claim 17, wherein the noise suppression filter air inlet includes a plurality of offset noise suppression filter air inlets formed by the exterior edges of the plurality of supplemental curvilinear walls and the curvilinear wall.

19. The compressor having a spiral noise suppression air filter of claim 13, wherein at least one of the base plate and the filter cap is a moldable polymer.

20. The compressor having a spiral noise suppression air filter of claim 1, wherein the filter media is a semi-permeable material.
